(19) United States
(12) Patent Application Publication
(10) Pub. No.: US 2011/0004761 A1
(43) Pub. Date: Jan. 6, 2011

(54) VIRAL FILE TRANSFER

(75) Inventors: Jonathan Graham Thackray, Cambridge (GB); Chris Lowe, St. Neots (GB)

Correspondence Address: c/o Greenberg Traurig, LLP, 77 W. Wacker Drive, Suite 3100, Chicago, IL, 60601-1732, US

(73) Assignee: CAMBRIDGE SILICON RADIO LTD., Cambridge (GB)

(21) Appl. No.: 12/815,724

(22) Filed: Jun. 15, 2010

(30) Foreign Application Priority Data
Jul. 1, 2009 (GB) 0911339.0

(51) Int. Cl. H04L 9/32

(52) U.S. Cl. 713/171; 713/176

(57) ABSTRACT

A method of distributing data between mobile devices while retaining control of that data. In particular, Digital Rights Management parameters are monitored and modified to control the distribution, and distribution is only permitted to devices which are approved or authorized. Mechanisms are provided for validating the identity of devices requesting transmission of the file.

### RELATED APPLICATION INFORMATION

This application claims the benefit of GB 0911339.0 filed on Jul. 1, 2009 the disclosure of which is incorporated herein by reference in its entirety.

### BACKGROUND

This invention relates to the control of distribution of data between mobile devices. Mobile devices are utilized for the storage and playback of media files, for example music and video. Media files are typically downloaded from a central repository under the instigation of the user, usually by the selection of a particular track or video from a library presented to the user.

Sharing of media between users is desirable, but presents technical and commercial challenges. Media files are licensed to users under a range of license models from unrestricted licenses allowing unlimited copying and distribution, to single-user licenses. In order to implement user to user distribution of media files a system to control that distribution in response to the license associated with each media file is required. This is technically challenging as once a media file is downloaded to a remote device direct control of that file is lost to the originating system. A means must therefore be implemented to retain control of the distribution of media files as per the license agreement associated with each particular file.

There is therefore a requirement for a system to permit sharing of media files between mobile devices while restricting that sharing as defined by the license associated with each media file.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a method of distributing data between mobile devices, the method being performed at a first mobile device and comprising the steps of requesting and receiving a signature from a second mobile device, verifying that the received signature is authentic, modifying digital rights management parameters of the data to indicate that the transmission has occurred, and transmitting the data to the second mobile device.

The signature may be verified using a global public key.

The first device may also request and receive a public key from the second device.

The method may further comprise the step of encrypting the data using the public key prior to transmission.

The signature may be verified using a central verification resource.

The data may be encrypted and the method may further comprise the step of decrypting the data using the private key of the first device prior to modifying the digital rights management parameters.

The data may be a media file.

The digital rights management parameters may indicate the number of times the data may be transmitted between devices.

The digital rights management parameters may indicate a time after which the file may not be transmitted between two devices.

There is also provided a mobile device configured to implement the methods described above.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a flow-chart of a method of media distribution;

FIG. 2 shows a schematic diagram of a security system; and

FIG. 3 shows a flow-chart of a method of controlled media distribution.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Generally the initial step in the distribution of a media file is the transmission of that file from a central repository where a ‘master’ copy of the file is held to a first user. The repository of files may be maintained by the publisher of the media or may be a media store which acts as a distribution point for a number of publishers. Users may access the repository via a web-interface or other software located on the device which is to receive the media file. The connection to the repository may be made directly, for example a mobile telephone may utilize the mobile telephone data network, or indirectly, for example a media playback device may be connected to a computer or other portable device with an internet connection.

Media files are typically made available under a defined license which often prohibits further distribution of copying of the media file. However, in certain cases it is attractive to publishers to allow limited distribution of media files beyond the initial user. For example, if the media file is a trailer for a TV show, it is desirable for that trailer to be distributed as widely as possible. Further distribution of media files may be performed by direct transfer of the file between devices. For example, mobile devices may utilize the Bluetooth standard to enable transmission between devices in close proximity.

Rather than allowing completely free distribution of media files, some restrictions may be desirable. For example, although wide distribution is desirable for advertising, it is also desirable to limit the time over which the advert is available to ensure it is only viewed whilst its subject matter is current. It is also important that media files are not edited, and distributed in edited form which could negatively portray the subject matter or publisher of the media file.

Mechanisms to impose these restrictions have conventionally been hard to implement because once the media file is transmitted from the repository the publisher no longer has any control over distribution of the file or the file itself.

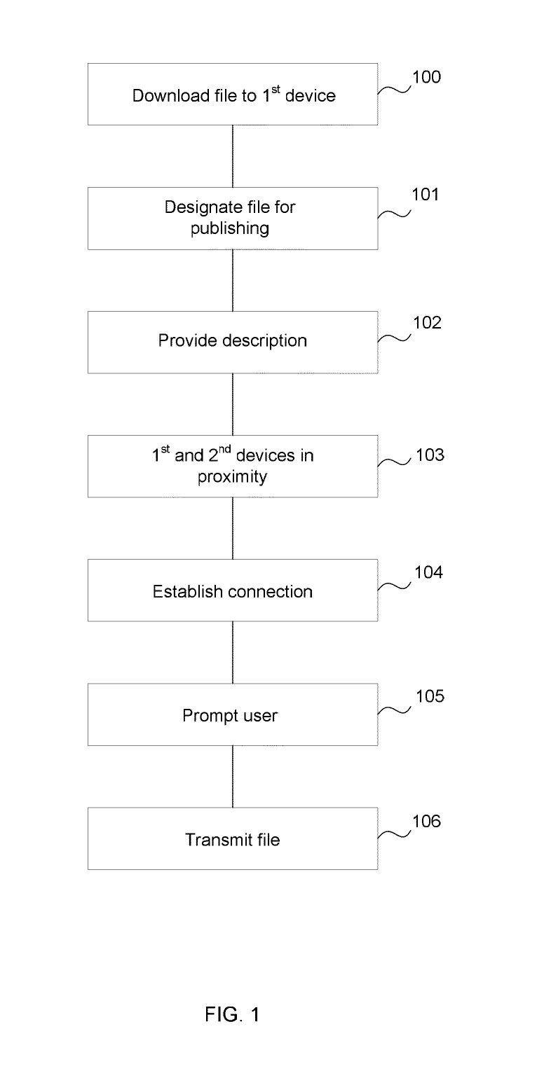

FIG. 1 shows a flow chart of a method of distribution of media between devices. At block 100 a media file is downloaded from a central repository to a first mobile device. At block 101 the user of that device designates the file as being published for others to receive, within the constraints of any DRM associated with the file. At block 102 a description of the media file is provided for access by others who may be interested in receiving the file. For example, the description may be entered by the user or may be sourced from tags associated with the file (e.g. ID3 tags or other metadata).

At block 103 the first mobile device comes within communications range of a second mobile device and the second mobile device observes that the first mobile device has files for publishing. At block 104 the two devices establish a connection and information is exchanged with regard to the published files. The second device may also be publishing files in which case information may be sent in both directions.

At block 105 the users of the devices are prompted with details of the media that is available on the other device and given the opportunity to download the files. Alternatively, this step may be performed automatically. For example, the mobile devices may be configured to automatically download files which meet a user's particular criteria. For example, particular genres, or particular types of media may be specified.

At block 106 the selected media files are transmitted between the devices and are thus available to both devices for playback or further distribution according to the method.

The method of FIG. 1 allows free uncontrolled distribution of a media file. DRM associated with the media file may provide restrictions on the ability of a user to play or use the file, without requiring modification of the software for performing that playback. For example, the file may have a time-to-live parameter specified in the DRM associated with the file. If that parameter is exceeded when a user attempts to play the file the device will be unable to perform that playback in accordance with the standard DRM provisions. The parameters available in conventional DRM systems may be somewhat limited. For example, the parameters may record a state associated with a file, but may not provide for updating of that state in response to distribution of the file. Modification of the available DRM parameters may therefore be required to implement the concepts disclosed herein. This distribution model is beneficial as it allows free distribution of media files, but also allows the preferable restrictions on playback time described above.

In order to implement more complex DRM schemes, or to be certain that even simple time-to-live schemes as discussed above are adhered to, there needs to be some control of the devices which may receive the media files, and/or some ability to modify parameters to allow tracking against the DRM license. For example, the DRM of a file may specify that it can be distributed between users only a certain number of times and the number of transmissions between devices must be monitored to ensure the number is not exceeded. Each device receiving the media file must be trusted to correctly check, modify and apply the parameters to ensure compliance with the DRM.

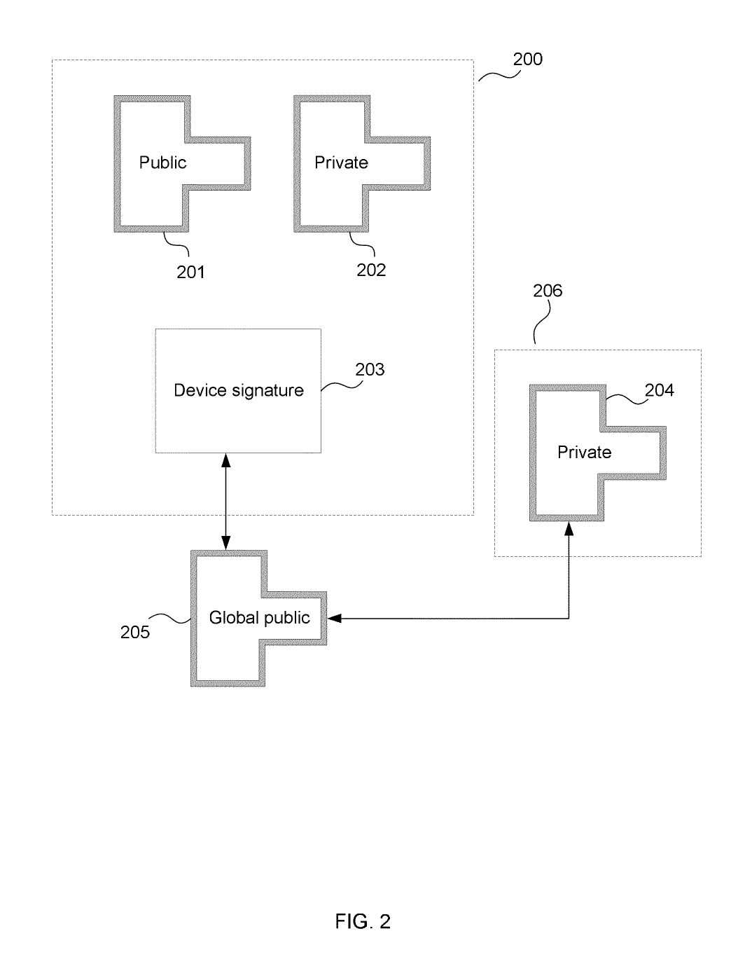

FIG. 2 shows a schematic diagram of a key structure to allow the definition of trusted devices, thereby allowing control of devices to which media files can be distributed and thus a method of ensuring compliance with DRM.

Each trusted device 200 has a Device Public key 201 and a Device Private key 202. Each device also has a Device Signature 203 related to the Device Public key 201. The Device Signature 203 is generated using a private key 204 held by the manufacturer 206. A globally known public key 205 can be utilized to check the validity of the Device Signature 203.

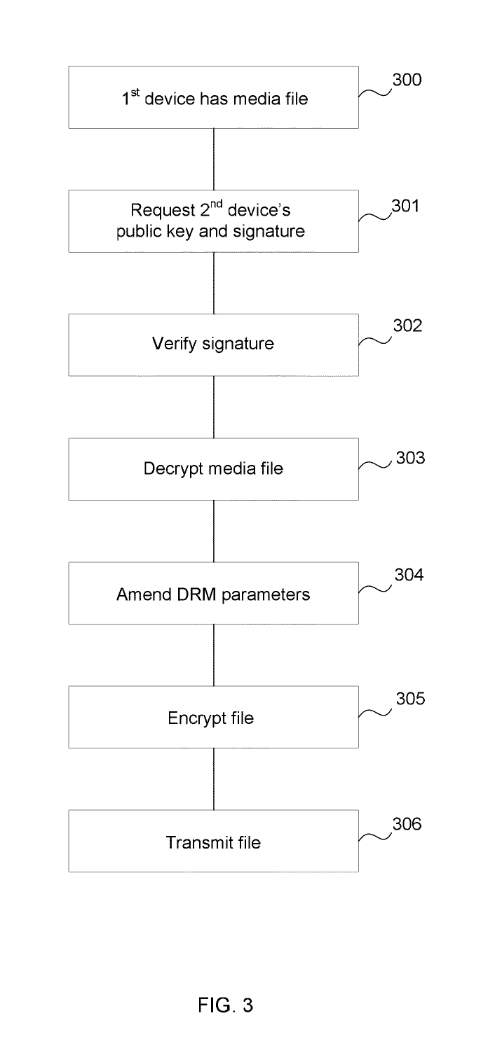

FIG. 3 shows a method of utilizing the system of FIG. 2 to permit distribution of media files while maintaining DRM control of those files.

At block 300 a first device has a media file which it has obtained from a repository, as explained above, and now wishes to transmit to a second device, for example as described in relation to FIG. 1.

At block 301 the first device requests the second device's Public Key and Signature. At block 302 the first device uses the globally known public key to verify the second device signature. If the signature is not genuine, or the device does not have a signature, the first device refuses to transmit the file and the interaction ends. Knowledge of the DRM associated with a file, and optionally a record of previous handling of the file, may be utilized by the first device to define what content is sent to the second device. For example, if the number of allowed transmissions has been reached a shortened “sample” may be sent to tempt the recipient into purchasing the full file. Furthermore, the file may be sent in full, but may have a restriction on the number of times it can be played and may not allow further transmission.

At block 303 the first device decrypts the media file using its own private key and checks that the DRM parameters of the file will allow the further distribution of the file. For example, the DRM parameters may include a ‘Time To Live’ parameter which indicates the number of times the file can be transmitted between devices. Once that parameter has reached its defined value (for example the parameter may be decreased with each transmission, with a value of zero indicating no more transmission is allowable) the device will refuse to transmit it again. As will be apparent, this step can be performed at any convenient point in the method prior to actual transmission.

At block 304 the first device amends the DRM parameters associated with the media file to indicate that it has been transmitted between two devices (this is done to both the transmitted version and the stored version). For example, the Time To Live parameter may be decreased by one transmission. At block 305, the first device then encrypts the file using the second devices public key. The encryption used does not need to be strong, but merely enough to spoil the file to prevent third party reception. For example, only every nth word (e.g. n=128) may be scrambled. An appropriate encryption technique may be selected to achieve the required level of encryption while minimizing processing capacity.

At block 306 the second device receives the encrypted file and may immediately decrypt it or store it for future decryption and playback.

The method of FIG. 3 may then be repeated by the first or second device for further distribution of the file. Each device checks that the device to which it is to transmit a file has the required signature, and so it is ensured that every device receiving the file is an approved device that will comply with the DRM requirements of the distributed file.

Devices are assigned signatures and keys by the manufacturer, publisher, or other responsible body if they are shown to comply with the requirements of the particular body. For example, a device may be approved if it is shown that it will (1) only send files to devices with a valid signature, (2) not divulge its private key, (3) comply with DRM parameters and make necessary modifications before transmission of files, and (4) only transmit encrypted files. The method of FIG. 3 operates by defining a frontier of trust for each media file. The frontier expands with the distribution of each file.

In an alternative method, rather than transmitting the actual file, the first device may transmit details of a location from which the file can be obtained. For example, once it is determined that the second device wishes to receive the media file the first device may transmit a link to cause the second device to access the file at the central repository. The verification steps of the method of FIG. 3 may be performed between the first device and second device, or may be performed between the second device and the repository.

In an alternative method of verifying the identity of the second device, the first device may enquire with a central location. For example, the second device may transmit a key or secret to the first device and the first device may then enquire with a central location whether that key or secret applies to a trusted device. The device may also enquire whether it is permissible to transmit a particular file to the device being checked.

The DRM parameters may vary depending on the device holding the media file. For example, the first device, which has downloaded the file from the central repository, may have free use of the file to play and distribute it. However, any device which receives the file from a first device may be restricted in its use of the file. For example, the second device may only be permitted to play the file a certain number of times, and may be restricted from further distribution. Such systems can be implemented by suitable modification of DRM parameters during implementation of the methods described above.

This description has been given with reference to the distribution of media files, but as will be apparent the techniques and methods described herein are equally applicable to the distribution of any kind of data. Similarly, the security provisions described are applicable in a range of applications, not only in the distribution of data or files.

The DRM parameters may be stored as part of the data, or as a separate, related, file.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise and exclusive list and a method or apparatus may contain additional blocks or elements.

The steps of the methods described herein may be carried out in any suitable order, or simultaneously where appropriate.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

What is claimed is:

1. A method of distributing data between mobile devices, the method being performed at a first mobile device and comprising the steps of
requesting and receiving a signature from a second mobile device,
verifying that the received signature is authentic,
modifying digital rights management parameters of the data to indicate that the transmission has occurred, and
transmitting the data to the second mobile device.

2. A method according to claim 1, wherein the signature is verified using a global public key.

3. A method according to claim 1, wherein the first device also requests and receives a public key from the second device.

4. A method according to claim 3, further comprising the step of encrypting the data using the public key prior to transmission.

5. A method according to claim 1, wherein the signature is verified using a central verification resource.

6. A method according to claim 1, wherein the data is encrypted and further comprising the step of decrypting the data using the private key of the first device prior to modifying the digital rights management parameters.

7. A method according to claim 1 wherein the data is a media file.

8. A method according to claim 1 wherein the digital rights management parameters indicate the number of times the data may be transmitted between devices.

9. A method according to claim 1 wherein the digital rights management parameters indicate a time after which the file may not be transmitted between two devices.

10. A mobile device configured to implement the method of claim 1.
